(19) United States
(12) Patent Application Publication
(10) Pub. No.: US 2006/0073447 A1
(43) Pub. Date: Apr. 6, 2006

(54) Method for training behavior during a nuclear, biological or chemical warfare attack and combat training system

(76) Inventors: Klas Bjork, Huskvarna (SE); Ingemar Emricson, Bankeryd (SE); Jonas Malm, Jonkoping (SE)

Correspondence Address: SWIDLER BERLIN LLP, 3000 K STREET, NW, BOX IP, WASHINGTON, DC, 20007, US

(21) Appl. No.: 10/947,376

(22) Filed: Sep. 23, 2004

(30) Foreign Application Priority Data
Sep. 23, 2004 (EP) 03078011.8-2221

(51) Int. Cl. G09B 9/00; G09B 19/00; G09B 25/00

(52) U.S. Cl. 434/218

(57) ABSTRACT

The present invention relates to a method for training behavior during a nuclear, biological or chemical warfare attack, including a number of players. The method includes determining exposure to a simulated nuclear, biological or chemical attack for each player; providing a signal indicating said exposure in at least one alarm simulator unit, said alarm simulating unit generating an audio/visible alarm signal; and establishing the effect of said exposure for each player.

### TECHNICAL FIELD

The present invention relates generally to civil defense and preparedness, and more specifically, to a method for training behavior during a nuclear, biological or chemical warfare attack. In the training method, exposure to a simulated attack is determined for a player, a signal indicating the exposure in at least one alarm simulator is provided, and the effect of the exposure for the player is established.

The present invention further relates to a combat training system which includes a central unit arranged to communicate with a plurality of wearable local units, wherein the local units are arranged to communicate exposure to a nuclear, biological or chemical agent.

### BACKGROUND OF THE INVENTION

It is well known to simulate effects of fire attacks and other firing weapons, such as mines, when training military personnel. Direct fire, which primarily is intended to have effect against a specific point, is usually simulated by means of optical equipment, whereby laser light commonly represents the fire and optical sensors are used to register hits. Indirect fire, whose nature is area covering, is usually simulated by means of radio waves, which are transmitted from some kind of transmitter antenna, for instance, at the simulated weapon, and whose effect is registered via one or more receiver antenna in proximity to potential targets. Another way of simulating indirect fire is by defining fields representing, for example, minefields, whereupon when a soldier enters such field, a hit evaluation is performed. A central unit can transmit coordinates for said fields, and each soldier then carries receiving equipment for receiving said coordinates and a memory for storing the received information. The receiving equipment and memory are conventionally incorporated in a vest/harness worn by the soldier together with a GPS-receiver providing position information for the soldier.

However, in order to make combat training even more realistic, other types of warfare can also be simulated, such as nuclear, biological and/or chemical warfare. This is done by defining fields, in the same manner as in the case with mine fields, contaminated with a nuclear, biological and/or chemical agent. In systems existing today, the soldier is informed by way of an audio signal from a loudspeaker of the harness/vest when he/she enters a contaminated field and after a predetermined time period the soldier must have taken measures to protect himself/herself from said agent, for example, by putting on a protective mask or a gas mask. If the soldier is not protected against said agent within the predetermined time limit, the soldier is considered to be injured or killed.

A continuing need exists to make combat training even more realistic and to improve the training of the behavior of the soldiers when exposed to nuclear, biological and/or chemical agents.

### SUMMARY OF THE INVENTION

In accordance with one embodiment of the invention, a method for training behavior during a nuclear, biological or chemical warfare attack is provided, for participation by a plurality of players in a simulated attack. The method includes determining exposure to a simulated nuclear, biological or chemical attack for each player. The exposure can be determined, for example, locally in equipment carried by the player or in a central unit and communicated to the player. The method further includes providing a signal indicating said exposure to an alarm simulator unit. The signal can be provided by sending a signal corresponding to the determined exposure for at least a sub-group of the players and by receiving said exposure signal in the alarm simulator unit. In another example, the exposure signal is received directly from a central unit. In a next step, said alarm simulating unit generates an audio/visible alarm signal. The task of those players who notice the alarm signal is now to inform the rest of the group of the nuclear, biological or chemical agent in order to minimize losses. In one example, where the alarm simulator unit is hand-held, handling of the alarm simulator unit is practiced, so that in real battle, the person responsible for the alarm simulator unit will notice when the unit is alarming. Also the routines for informing the rest of the players is practiced.

In another example, the alarm simulator unit is vehicle carried or stationary. Also in this example, behavior of the players is trained in order to secure that the alarm will be noticed and in order to secure that all the players are informed of the danger. The last step of the method includes establishing the effect of the exposure on each player. This step may include establishing for each player for how long time the player has been exposed to the attack without wearing means protecting against said exposure. In a simple embodiment, this is achieved by establishing when the exposure is initiated and when the player initiates use of protection means against said exposure.

In a preferred embodiment of the method according to the present invention, the extent of exposure is determined and the intensity of the alarm signal is dependent upon the extent of exposure.

Another aspect of the invention is to provide a combat training system which includes a central unit communicating with a plurality of wearable local units, wherein said local units each are arranged to determine exposure to a nuclear, biological or chemical agent. The system includes at least one alarm simulator unit, wherein each alarm simulator unit is arranged to provide exposure related data upon exposure to an agent, wherein said alarm simulator unit has alarm generating means arranged to generate an alarm signal based on said exposure signal, and wherein each alarm simulator unit is a separate entity.

In accordance with another aspect of the invention, the exposure related data is provided from one of the local units. In accordance with yet another embodiment, the exposure related data is provided from the central unit. In yet another example, the alarm simulator unit is arranged to determine exposure to the nuclear, biological or chemical agent. The alarm simulator units may be hand-held, vehicle-carried, or stationary.

In yet another embodiment of the invention, the exposure related data is arranged to indicate level of exposure and in that said alarm generating means are arranged to indicate said level. For example, the exposure related data is arranged to indicate a low, non-fatal level or a high, fatal level of exposure.

### BRIEF DESCRIPTION OF THE DRAWINGS

FIG. 1 shows a system for combat training of soldiers according to one aspect of the present invention;

FIG. 2 shows a schematic diagram over equipment in a harness and a protective mask or gas mask of a soldier; and

FIG. 3 shows a schematic diagram of an alarm simulator unit according to an embodiment of the present invention.

### DETAILED DESCRIPTION OF THE PREFERRED EMBODIMENTS

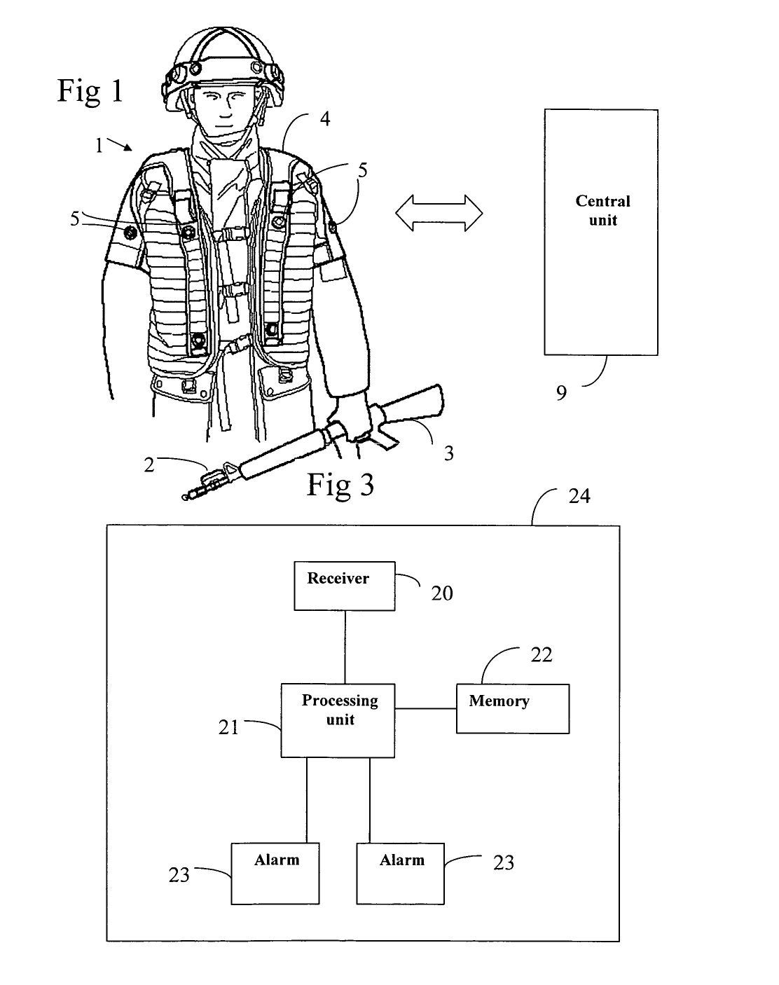

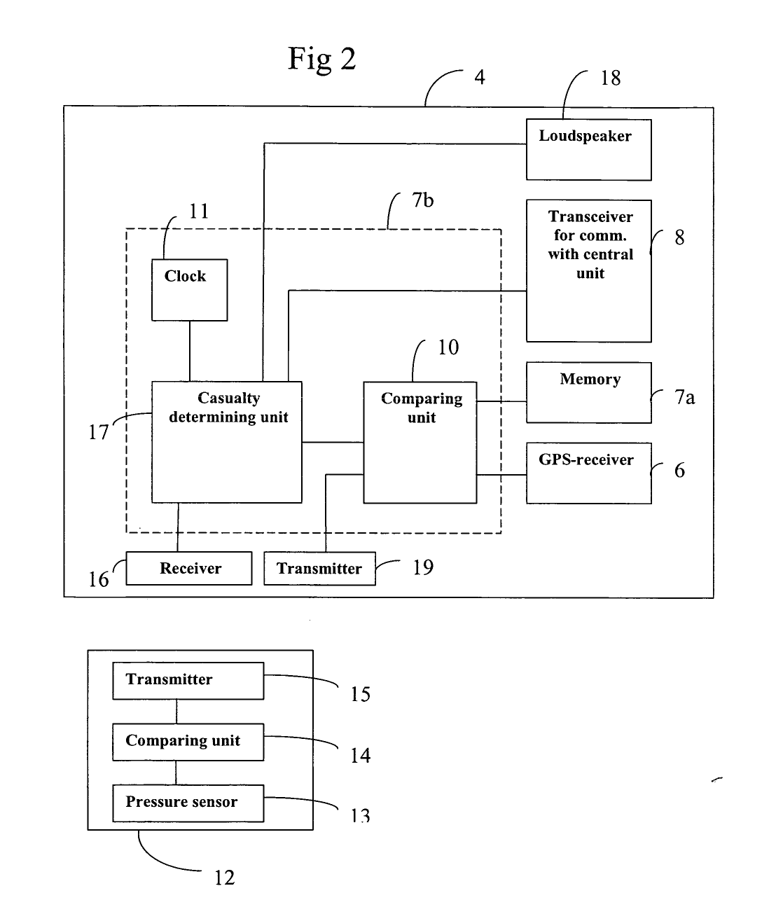

Referring now to FIG. 1, a system for combat training of soldiers 1 includes a laser-based shooting simulator 2 arranged on a weapons 3 used in the training, and a harness 4 or vest worn by each soldier participating in the training exercise. Each harness/vest 4 is provided with detectors 5 for detecting hits of the shooting simulators 2 (used by other participating soldiers), a GPS-receiver 6 for receiving position data, a memory 7a for storing data, a processing unit 7b for processing data, and radio communication means 8 for exchanging information with a central unit 9. The GPS-receiver 6, memory 7a, processing unit 7b and radio communication means 8 are shown in FIG. 2. The central unit 9 is arranged to send coordinate data to the harnesses/vests 4 defining a field and a type of warfare associated with said field. The warfare type is, for example, a field contaminated with a nuclear, biological or chemical agent.

In FIG. 2, the field coordinates received from the central unit 9 via the radio communication means 8 are stored in the memory 7a together with information regarding field type (radioactive field, biologically or chemically contaminated field). The processing unit 7b of each harness/vest 4 is arranged to compare the field coordinates from the memory 7a with position data from the GPS-receiver 6 in a comparing unit 10. When the comparing unit 10 has determined that the soldier is within a contaminated field, the comparing unit outputs data concerning the entrance into the contaminated field, the time of entrance and type of contamination. The time data can, for example, be fetched from the GPS-data or a clock 11 of the processing unit 7b. In an extended embodiment, the contaminated fields include a number of sub-fields, each with a different level of contamination. In that case, the comparing unit is also arranged to output the contamination level. The outputted data is fed to a casualty determining unit 17 of the processing unit 7b and to a transmitter 19 in the harness/vest 4, which shall be described more in detail below.

In order to protect against the contamination, the soldiers 1 should put on protective means 12. In the non-exclusive example herein described, the protective means 12 is a protective mask or a gas mask. The mask, which is suited for training use, is provided with a pressure sensor 13 arranged to sense the air pressure inside the mask. The pressure sensor 13 outputs air pressure data to a comparing unit 14 of the mask. The comparing unit 14 is arranged to compare the sensor data with a preset or predetermined curve in order to determine whether the soldier has properly put on the mask or not. When the mask is properly on, the soldier is protected against the contamination. The comparing unit 14 feeds an ON-signal to a transmitter 15 of the mask when the mask is properly on. The transmitter 15 sends the ON-signal, for example, via radio or IR to a receiver 16 of the harness/vest 4. The casualty determining unit 17 of the harness/vest 4 is arranged to input the ON-signal from the receiver 16 and the data from the comparing unit 10 concerning time of entrance into a contaminated field and type of contamination. The casualty determining unit 17 is arranged to establish for how long a time period the soldier has been exposed to the contamination without wearing the protective means. In a simple example, this is done by comparing the time when the exposure is initiated with the time when the player initiates use of protecting means against said exposure. The casualty determining unit 17 of the harness/vest 4 then fetches time data from the clock 11 upon reception of the ON-signal and establishes the time difference between the time data from the clock and the time data of the information from the comparing unit 10. If the soldier is exposed without wearing the mask longer than a predetermined time period, the soldier is considered to be killed. Then, the casualty determining unit 17 is arranged to create a message and send it to the communication means 8 for distribution to the central unit 9. The message includes information regarding the identity of the killed soldier, the time and place of the death and the reason of the death (exposure to a nuclear, biological or chemical agent). Further, the casualty determining unit 17 provides a signal to a load speaker 18 of the harness/vest 4 informing the soldier of the death.

However, this simple example does not handle a situation where the soldier leaves the contaminated field within the predetermined time period. In an extended example, the comparing unit 10 is arranged to repeatedly establish whether the soldier is still within the contaminated field after exposure has been initiated. In this extended example, the casualty determining unit 17 is arranged to determine the total amount of time the soldier has been in the contaminated field within a given time frame, e.g., within the last hour, and to compare this total amount of time with the predetermined time period. In the case when the contamination level also is established, a total exposure is determined instead of a total time period. The total exposure is determined by multiplying each exposure level with a time period associated with said exposure level, and comparing the total exposure with a predetermined exposure value.

As seen in FIG. 3, an alarm simulator unit 24 is designed to have the size and weight of real instruments used by that army for detecting a specific type of contamination (nuclear, biological or chemical) and alarming upon detection. In this way, handling of the instrument can be practiced in a realistic manner. In order to further increase the realism, the alarming function of the replica or simulator unit 24 is the same as the alarming function of the real instruments in use. For example, if the instruments have means for generating an acoustic alarm signal, also the replica is arranged to provide an acoustic signal. If the instruments in use are arranged to provide the alarm by emitting visible light, also the replica has a light emitter. Other alarming means of the alarm simulator unit could be a buzzer, a text display and/or an instrument giving an analogue indication, e.g., a pointer-type instrument.

As previously described in relation to FIG. 2, the comparing unit 10 of the harness/vest 4 outputs data concerning entrance into a contaminated field to the casualty determining unit 17. The outputted data is also fed to the transmitter 19 of the harness/vest 4 arranged to broadcast a message including said data. The transmitter 19 is, for example, a transmitter for radio transmission or an IR-transmitter. A receiver 20 of the alarm simulator unit 24 is arranged to receive messages from the comparing unit 10 of the harness/vest 4 indicating entrance into a contaminated field. The message is fed to a processing unit 21 arranged to initiate the alarm upon entrance into the contaminated field. The processing unit 21 is arranged to read the information of the message indicating type of contamination and to establish whether the alarm simulator unit 18 is arranged to simulate an instrument alarming for that type of contamination. This is done by comparing the contamination type with a preset contamination type stored in a memory 22. If the contamination type of the memory 22 and the received message are identical, then the processing unit 21 feeds a signal to one or more alarms 23 initiating said alarms.

In another example (not illustrated), at least parts of the comparing unit 10 is arranged in the alarm simulator unit. Then, the processing unit 21 of the alarm simulator unit 24 can be arranged to provide a variable signal to the alarms 23 wherein the strength of the signal is increasing when the alarm simulator unit approaches the contaminated field, based on algorithms included in the processing unit 21. In yet another example (not illustrated), which is especially suitable for a stationary alarm simulator unit 24, the GPS-receiver 6, memory 7a, transceiver 8 and comparing unit 10 are disposed in the alarm simulator unit 24. Then, the alarm simulator unit 24 is arranged to receive coordinates for the contaminated field via the transceiver 8 and to determine whether the unit 24 is exposed to the contaminated field in the same manner as described above.

In combat training, the soldiers are divided into groups of, for example, five to ten persons. In each group, one of the soldiers is responsible for the alarm simulator unit 24 arranged to alert when the simulator unit enters a contaminated field. A method for training behavior during a nuclear, biological or chemical warfare attack then comprises determining for each soldier if the harness/vest 4 has entered a contaminated field. As previously described, the processing unit of the harness/vest 4 determines if the harness/vest 4 has entered a contaminated field. The method further includes that, for the soldier of each group responsible for the alarm simulator unit 18, a signal is sent to the alarm simulator unit indicating said exposure. After that, the alarm signal is processed by the alarm signal unit and an alarm is generated. The soldier responsible for the alarm simulator unit is now supposed to act in order to warn the other group members of the danger in the same manner as in real battle. For each soldier it is then established for how long time he/she has been in the contaminated area before taking measures to protect himself/herself. This is established individually in each harness/vest processing unit.

1. A method for training behavior during a nuclear, biological or chemical warfare attack, including a number of players , comprising the steps of:
determining exposure to a simulated nuclear, biological or chemical attack for each player;
providing a signal indicating said exposure in at least one alarm simulator unit, said alarm simulating unit generating at least one of an audio and visible alarm signal, and
establishing the effect of said exposure for each player.

2. A method according to claim 1, wherein the step of providing a signal includes sending the exposure indicating signal to the simulator unit for a sub-group of players.

3. A method according to claim 1, wherein the step of establishing the effect includes establishing for each player for how long a time period the player has been exposed to the attack without wearing means protecting the player against said exposure.

4. A method according to claim 3, wherein the step of establishing the effect further includes establishing when the exposure is initiated and when the player initiates use of protection means used by the player against said exposure.

5. A method according to claim 1, wherein the step of determining exposure includes determining the extent of exposure, and wherein the intensity of the alarm signal is dependent upon the extent of exposure.

6. A training system comprising:
a central unit communicating with a plurality of wearable local units, wherein said local units each are arranged to determine exposure to a nuclear, biological or chemical agent; and
at least one alarm simulator unit, wherein said alarm simulator unit is arranged to provide exposure related data upon exposure to an agent, wherein said alarm simulator unit includes alarm generating means arranged to generate an alarm signal based on said exposure signal, and wherein each alarm simulator unit is a separate entity.

7. A training system according to claim 6, wherein at least one of the local units is provided with a transmitter for transmitting said exposure related data, and wherein said alarm simulator unit is provided with a receiver for receiving said exposure related data.

8. A training system according to claim 7, wherein each alarm simulator unit is arranged to receive said exposure related data from a predetermined local unit.

9. A training system according to claim 7, wherein the received exposure related data is arranged to indicate level of exposure, and wherein said alarm generating means are arranged to indicate said level.

10. A training system according to claim 9, wherein the received exposure related data is arranged to indicate a low, non-fatal level or a high, fatal level of exposure.

11. A training system according to claim 6, wherein each wearable local unit is worn by individuals participating in the combat training system.

12. A training system according to claim 6, wherein each alarm simulator unit includes means for generating an audio signal.

13. A training system according to claim 6, wherein each alarm simulator unit includes means for generating a visible light signal.

14. A training system according to claim 6, wherein each alarm simulator unit includes means for generating a text display.

15. A training system according to claim 6, wherein each alarm simulator unit includes an instrument giving an analogue indication, such as a pointer type instrument.

16. A training system according to claim 6, further comprising processing means arranged to control said alarm generating means in dependence of warfare type.

17. A training system according to claim 6, wherein the alarm simulator unit is hand-held.

18. A training system according to claim 6, wherein the alarm simulator unit is vehicle-carried.

19. A training system according to claim 6, wherein the alarm simulator unit is stationary.

20. A training system according to claim 6, wherein the training system is a combat training system.
